(19) United States
(12) Patent Application Publication
(10) Pub. No.: US 2008/0166166 A1
(43) Pub. Date: Jul. 10, 2008

(54) METHOD AND APPARATUS FOR PERFORATING A PRINTABLE SURFACE

(76) Inventors: VIKTORS BERSTIS, Austin, TX (US); HERMAN RODRIGUEZ, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/619,737

(22) Filed: Jan. 4, 2007

(51) Int. Cl. B41J 2/275

(52) U.S. Cl. 400/124.11; 101/19

(57) ABSTRACT

A perforating print head for a printing device comprising a frame assembly, a plurality of perforating printing assemblies coupled to the frame assembly, each having an impact element further comprising a first end for impacting a printable media surface and a second end suitable for receiving a driving force, and a drive mechanism suitable for applying the driving force to the second end of the impact element. The drive mechanism may be suitable for applying sufficient driving force to the second end of the impact element to allow the first end of the impact element to perforate the printable media surface.

### FIELD OF THE INVENTION

The present invention relates generally to the field of printing devices and more particularly to a method and apparatus for perforating a printable surface.

### BACKGROUND OF THE INVENTION

Impact printing devices are widely known in the art and provide many useful features for transferring images from electronic form to physical form. Many types of impact printers are now in use as output devices for computers, data processors or similar devices. As is generally known, impact printing devices, such as dot matrix printers, may vary greatly with respect to size, cost and functionality. Generally, however, most dot matrix printing devices achieve image printing by printing a plurality of dots which, when viewed together, form an overall image. A dot may be formed by a plurality of print impact elements on a printing device head. To accomplish dot formation, print impact elements may impact with a print hammer resulting in the print impact elements impacting the surface of the medium upon which the image is to be printed. Among others, serial type impact printers capable of imprinting characters and signs of all sorts and suitable for high-speed printing operation are widely utilized in many industries.

When using an impact printer, is often desirable to partition a printed surface into segments, individual images, or the like, depending upon the end-use of images printed on the medium. As a result, it is common to use scissors, paper cutters, pre-cut paper computer forms, pre-perforated paper forms, including a variety of sizes and shapes, as well as paper stock when printing on a computer, controlled printer, or a copier, or a fax machine. For instance, scissors may be utilized to create a physical image corresponding to the desired layout of a printed image, such that the resultant physical form represents a physical object. To aid in manual segmentation of a printed surface, there exist many computer based program products that provide the capability to print the outline of an image. For instance, an outline may be formed using a standard computer printer by printing the outline of an image or form. This may allow a user to cut the printed surface with a sharp object such as scissors, a small cutting knife, card punch, or the like to produce a physical image cutting by alongside the edge of the printed trace of the image. Additionally, a cut-along guide may be printed on the printed medium to form a pattern as a guide to the cutting instrument. However, this may be very cumbersome and imprecise, often resulting in the formation of incorrect or undesired shapes, and may further cause finger lacerations, especially when cutting objects are handled by small children.

In addition to manual partitioning, various partitioning methods exist that allow an individual to create a custom shape from a cutting mechanism or pre-imprinted perforations on paper. However, these methods typically allow very limited range of shapes and forms of cuts or perforations. Most often, these perforations are along a straight line, such as perforation accomplished by tally receipt printing devices, or card printing on pre-cut or pre-perforated paper stock accomplished via a dedicated label printing device, such as those used to print round compact disk labels, and the like. The cost and usability of these known solutions are typically in excess of twice that of using rectangular paper stock for printing devices. Some devices, such as plotters, have been fitted with cutting knives and razors to avoid the cost of purchasing pre-perforated paper. However, the degree of control may be limited when attempting to cut small and complex figures, generally attributable to the motion and momentum associated with the cutting blade of the plotter. Another typical method for creating a physical form from printer paper may be to utilize a tracing device, where one end of the device may be superimposed over the layout of an image, and the other end of the instrument contains a sharp edge to cut a congruent image on another piece of paper. Again, however, the degree of control may be constrained by a user's ability to create precise shapes, especially when tracing small or complex figures.

Additional methods of creating a physical paper image that represents a form or layout of a printed image exist, such as utilized pre-cut or perforated printer stock paper in the form of an image. The paper surface to be printed may be attached and held in place via same form of adhesive or glue to a printable surface. Once an image is printed on the print surface, the precut or pre-formed image may be separated from the backing material, exposing and producing the physical form of an image. Precut or perforated paper stock for printing devices is available in a variety of sizes, ranging from single sheet paper leaves, or in continuous perforated paper, and is available in a variety of rectangular sizes ranging from small, precut or perforated sizes ranging from 2 inches wide by 2 inches long, to larger sizes such as 8.5 inches wide by 11 inches long. The printing device stock may also contain guides for folding the paper, or pre-folded alignment lines, to make it convenient for a user to fold the paper once the image or information has been printed on the paper. Disadvantageously, however, the cost of custom pre-cut or pre-perforated printer paper stock is much more expensive than regular rectangular paper stock. In the case of pre-perforated printer paper, the outline form of the perforation is usually performed in bulk by the manufacturer, where the perforation is done on the sheet of paper typically in a rectangular, circular, or other pre-arranged shape. Once printed, the image may be separated from the perforated paper sheet, by tearing along the prior perforations, thus exposing the form of the pre-cut or pre-perforated of object.

None of these solutions provides precise, customized perforation of a printable surface. A result, it would be beneficial to have a method and apparatus that provided perforation in the form of a two dimensional figure or drawing of an object regardless of size and shape of the figure or drawing as a printable sheet is fed through a printing device. It would also desirable to enable the same level of control when creating perforations on paper by automatically performing the partition or perforation on the subject paper at precise locations in relation to the image or drawing.

Consequently, it would be advantageous if a method and apparatus existed which provided perforation of printable media as media is fed through a printing device.

### SUMMARY OF THE INVENTION

Accordingly, the present invention is directed to a method and apparatus for providing perforation by a printing device. In a first aspect of the present invention, a perforating printing device head may be provided. A perforating printing device may comprise head of a frame assembly, a plurality of perforating printing assemblies coupled to the frame assembly, each having an impact element further comprising a first end for impacting a printable media surface and a second end suitable for receiving a driving force, a drive mechanism suitable for applying a driving force to the second end of the impact element. The impact element drive mechanism may be suitable for applying sufficient driving force to the second end of the impact element to allow the first end of the impact element to perforate the printable media surface. Perforating printing device head perforating elements may be elongated to protrude beyond a perforating printing device head housing. Elongated perforating elements may be sufficiently sharp to perforate the surface of a medium that may be inserted through a printing device platen. Perforating printing device head perforating elements may perforate substantially through print medium, or may create near-perforations in any desired configuration.

In a second aspect of the present invention, a method for perforating a printable media surface is considered. Method may provide perforation for a medium fed through an impact printing device, such as paper, transparency film, cardstock or the like. Perforation may be of any type desired by a user, such as straight across for segmentation of a printed medium, or perforation may trace an outline of an object, shape or like figure. Method may include receiving partitioning instructions from a source operably coupled to a printing device having perforation capabilities. Method may configure elongated perforating impact elements to achieve desired perforation. Method may include executing an application program to generate perforation data, generating parameters defining a total number of columns of perforation data, including a starting block and an ending block, determining a number of blocks of perforation data in each column of perforation data, allocating an area of memory as a perforation buffer based on the total number of columns of perforation data, reading columns of perforation data, outputting columns of perforation data to a printing device head having a plurality of print impact elements suitable for providing perforation, and perforating a printable media surface according to the columns of perforation data. Method may further include providing substantial force to impact printing device perforating impact elements to puncture the surface of a print medium.

In a third aspect of the present invention, a printing system including a perforating print head is considered. Printing system may be suitable for providing perforation of a printable media surface. Printing system may be comprised of a memory, an area of which may be designatable as a media perforation buffer, a processor suitable for executing an application program to generate perforation and determine a configuration for perforation, and a controller suitable for receiving the configuration for perforation and executing perforation.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a perforating printing device head in accordance with an embodiment of the present invention;

FIG. 2 is an illustration of a printing device head perforation assembly that may be implemented with a perforating printing device head in accordance with an exemplary embodiment of the present invention;

FIG. 3 is an illustration of a printing device providing feed-through perforation of a sheet of printable media in accordance with an embodiment of the present invention;

FIG. 4 is an illustration of a sheet of printable media perforated by a printing device in accordance with an embodiment of the present invention;

FIG. 5 is a flow diagram representing a process for perforating a printable media surface in accordance with an exemplary embodiment of the present invention; and

FIG. 6 is a block diagram of a system for perforating a printable media surface in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

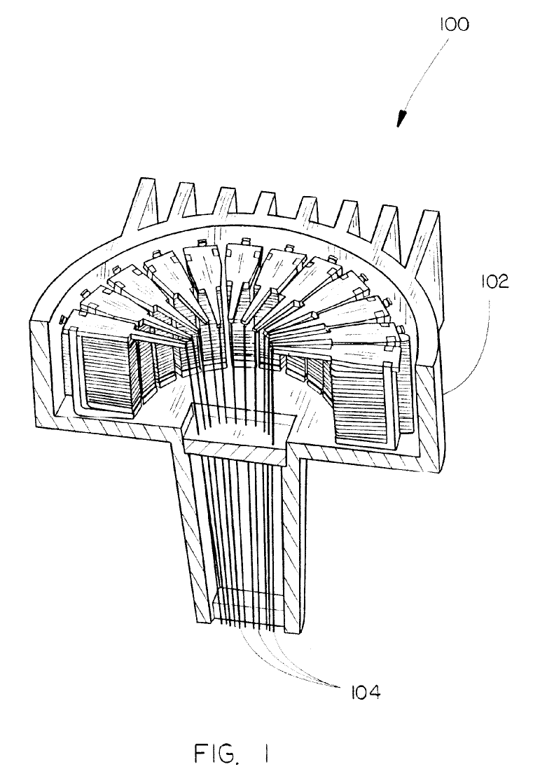

Referring to FIG. 1, a perforating printing device head 100 suitable for providing perforation of a printable surface while an image is printed is shown. Perforating printing device head 100 may be comprised of a frame assembly 102, a plurality of perforating printing assemblies coupled to the frame assembly 102, each having an impact element 104 further comprising a first end for impacting a printable media surface and a second end suitable for receiving a driving force, and a drive mechanism suitable for applying the driving force to the second end of the impact element. The drive mechanism may be suitable for applying sufficient driving force to the second end of the impact element to allow the first end of the impact element to perforate the printable media surface. The drive mechanism may also be suitable for allowing partial impact of an impact element with a media surface without penetrating the entire thickness of the medium. In this manner, a medium crease point may be created.

Perforating printing device head 100 may provide printing of characters in accordance with print heads known in the art. Characters may be comprised of one or more character blocks, or positions on the print medium in which a character is printed. A character block may be segmented into a number of smaller elements that identify positions in which dots can be printed to make up a character. The greater the number of elements, the greater the number of dots that may be used to print a character and therefore the greater is the resolution of the character. Perforating printing assemblies may be arranged circularly, linearly, or in any configuration. Additionally, perforating printing device head 100 may be mountable to a printing device. The respective printing assembly may comprise a movable piece and a printing impact element which may move integrally. For instance, the printing impact element may be fixed to a tip end of the movable piece, which may be mounted to a base.

Perforation may be provided in the form of a set of punctures by pressing a perforating impact element against the surface of a sheet of printable media while moving in a predetermined direction relative to the media. In one embodiment, a plurality of perforating impact elements may be arranged to converge toward each other. A drive mechanism of a perforating assembly may include at least one permanent magnet and solenoid suitable for actuating the perforating impact element. An individual perforating impact element carrying armature may be rigidly attached to the magnetic assemblies or located in a housing so that the perforating impact element carrying armature may be directly attached to one support of a magnetic coupling in a swiveling manner, and the other magnetic coupling support may be utilized as a stroke limiter for the printing element carrying armature. The perforating printing device head 100 may also provide housing for an armature magnet.

In one embodiment, perforating printing device head frame assembly 102 may be coupled to at least one printing assembly for printing characters, having a printing impact element for printing a character block segment and a drive mechanism for driving the printing element. A printing impact element may be rigidly mounted on an armature by soldering, gluing, spraying of synthetic material, sintering, crimping, or like methods of fastening. Printing impact elements, such as wires, rods, pins or the like may be arranged to imprint characters, signs and the like on the surface of printable media in a desired configuration. Imprinting of characters may be provided in the form of a set of dots by pressing the print wires against an ink ribbon that faces the piece of paper while moving in a predetermined direction relative to the piece of paper. A plurality of printing impact elements may be arranged to converge toward each other. A drive mechanism of a printing assembly may include at least one permanent magnet and solenoid suitable for actuating the print impact element. In previously known matrix printer head designs, an individual printing impact element carrying armature may be rigidly attached to magnetic assemblies or located in a housing so that the printing element carrying armatures may be directly attached to one support of a magnet coupling in a swiveling manner, and the other magnet coupling support is used as a stroke limiter for the printing impact element carrying armature. The perforating printing device head 100 may also provide housing for an armature type magnet.

A print impact element drive mechanism for each print impact element may include a magnetic circuit comprising a coupling having a coil core around which a coil is wound, a coupling plate, and an actuating spring mechanism. Coil may be energized by a signal from print control, permitting control over the time and sequence of the driving of each print impact element. Movement of the actuating spring mechanism may be transmitted through an electromagnetic actuator having an armature to the print impact element. The print impact element driver unit may be partially enclosed in a housing such as a cover, which may limit the stroke of the electromagnetic actuator. In a standby position, the tip end of the print impact element may be located back from a distal end surface of the print impact element guide, and the print impact element length may be selected such that an ink meniscus formed in a front portion of the print impact element guide hole covers the tip end of the wire. When the coil is energized by the signal from print control, the actuating spring mechanism confronting the coil core may be attracted. The electromagnetic actuator to which the actuating spring mechanism is secured may move to project the print impact element which engages a distal end of the electromagnetic actuator. The first end of the print impact element may project through the ink meniscus, carry ink thereon, and impact a sheet of printable media to transfer the ink to the printer paper. When the print impact element is in a standby position, the first end thereof may be located inside of the end surface of the print impact element guide so that an ink meniscus may be formed in front of the first end of the print impact element. Accordingly, ink may be attached successively to the first end of the print impact element as the latter is projected and retracted.

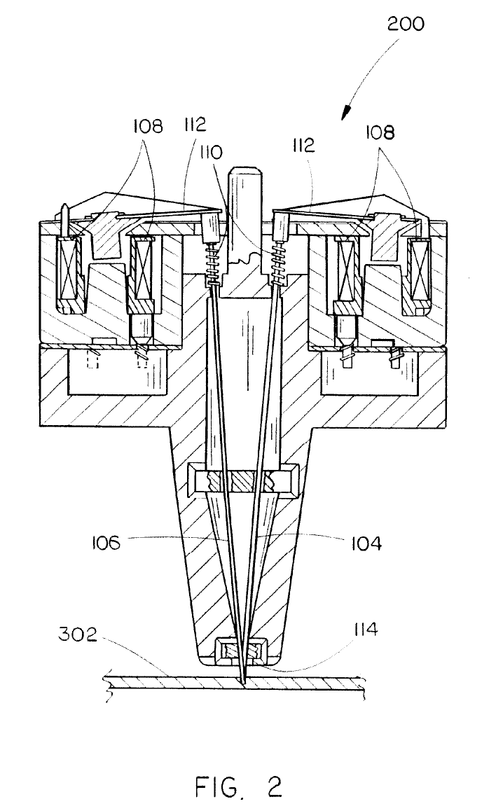

Referring to FIG. 2 an illustration of a printing device head perforation assembly 200 that may be implemented with a perforating printing device head in accordance with an exemplary embodiment of the present invention is shown. In addition to including a plurality of print impact elements known in the art, the perforating printing device head 100 may be further comprised of at least one perforation assembly 200 for perforating the surface of a sheet of printable media. A perforation assembly 200 may comprise a movable piece and a perforating impact element 104 having a first and second end which may move integrally. For instance, the perforating impact element 104 may be fixed to a first end of the movable piece, and a second end may be mounted to a base. The perforation assembly 200 may be configured to face the movable piece, and a drive current may be supplied to the perforation assembly 200 to allow a perforating impact element 104 to strike against the surface of a sheet of printable media. The control circuit may comprise a head driver for controlling passage of current to each of the perforation assemblies. Perforation assembly 200 may include a perforation impact element 104 for contacting the media and a drive mechanism for driving the perforation element. A perforating impact element 104 may be rigidly mounted on an armature by soldering, gluing, spraying of synthetic material, sintering, crimping, or like methods of fastening. A perforating impact element 104 may be a wire, rod, pin or the like and may be arranged to perforate the surface of printable media, signs and the like on the surface of printable media in a desired configuration. Perforating impact element 104 may be substantially similar to such known printing device head print impact elements; however, a perforating impact element 104 may be sufficiently elongated to extend beyond a perforating printing device head guide when actuated. Additionally, a perforating impact element may be actuated with force sufficient to puncture partially, substantially or completely through a printable media surface. A perforating impact element 104 may puncture the surface of the medium in a configuration determined from instructions received by a printing device processor configured to execute a perforate application. Perforating impact elements 104 may provide any desired perforation of a printable surface. For example, perforating printing device head 100 may provide perforation around an image, across a printable surface in any direction, or any desired perforation configuration.

In one embodiment, a perforating impact element driver unit for each perforating impact element may include a magnetic circuit comprising a coupling having a coil core 108 around which a coil is wound, a coupling plate 112, and an actuating spring mechanism 110. Coil may be energized by a signal from print control, permitting control over the time and sequence of the driving of each print impact element. Movement of the actuating spring mechanism 110 may be transmitted through an electromagnetic actuator to the print impact element. The perforating impact element driver unit may be partially enclosed in a housing such as a cover, which may limit the stroke of the electromagnetic actuator. In a standby position, the first end of the perforating impact element may be located back from a distal end surface of the perforating impact element guide, and the perforating impact element length may be selected to allow desired puncture depth. When the coil is energized by the signal from perforation control, the actuating spring mechanism confronting the coil core may be attracted. The electromagnetic actuator to which the actuating spring mechanism 110 is secured may move to project the perforating impact element which engages a distal end of the electromagnetic actuator. The first end of the perforating impact element may project through the perforating printing device printing assembly guide 114 and impact a sheet of printable media to puncture the surface of the printable media. When the perforating impact element is in a standby position, the first end thereof may be located inside of the end surface of the perforating impact element guide.

It is further contemplated that perforating printing device head 100 may be comprised of at least one combination perforating printing assembly. For instance, the perforating assembly 200 of FIG. 2 may be modified to allow both printing and perforating from the same impact element. Perforating printing assembly may include at least one perforating-printing element suitable for printing a character on the surface of a printable medium and puncturing partially, substantially, or completely through the printable medium. The perforating printing assembly may be configured to face a movable printing device component, and a drive current may be supplied to the perforating printing assembly to allow a printing impact element to strike against a platen by magnetic attractive force. The control circuit may comprise a head driver for controlling passage of current to each of the perforating printing assemblies. To this end, perforating printing device head may include a perforating-printing assembly driver suitable for configuring a perforating-printing element for the desired output, either impacting the surface of the printable medium with ink with a sufficient amount of force to transfer the ink to the medium, or impacting the surface of the printable medium without ink with an increased amount of force to puncture the surface of the printable medium. Perforating-printing assembly may further comprise a moveable ink ribbon or deposit mechanism suitable for retracting when a perforating printing assembly receives perforate instructions. Ink ribbon or deposit may revert to a position allowing a perforating printing assembly impact element to acquire a deposit of ink to transfer onto medium when printing instructions are received.

Perforating printing device head 100 may be capable of perforating the outline of an image while printing any desired text, objects, figures or the like within the boundaries of the perforation, outside the perforated boundary, or both as may be desired by a user. It is further contemplated that perforating printing device head 100 may be suitable for single or multiple pass perforation. For instance, perforating printing device head 100 may achieve desired perforation in one pass across a printable media surface, or in several passes. Single or multiple pass perforation may depend on desired perforation, composition of perforating printer pins, composition of printable media or like characteristics.

It is contemplated that protrusion level of perforating printing device impact elements may be adjustable according to thickness of a medium surface. For instance, puncturing completely through a medium having a thickness value of “x” may require corresponding perforating impact element protrusion of “y”. In this manner, perforating printing device head 100 may be suitable for perforating any desired medium that may be fed through a printing device, such as 20-pound stock paper, 5 mm transparency material, cardstock and the like. A device driver for the perforating printing device may control the positioning and protrusion of the impact elements in the perforating printing device head 100. This device driver may provide similar addressing and positioning of the perforating printing device head 100 as for a printed document. It is further contemplated that the drive force may be adjustable according to a corresponding printer color selection. For instance, the printing device 300 may be configured to receive instructions such an indication to print a specific color. Printing device 300 may determine that a specific print color instruction is an instruction to perforate, print or print and perforate and print at a given location. Location may be a dot, pixel or like location.

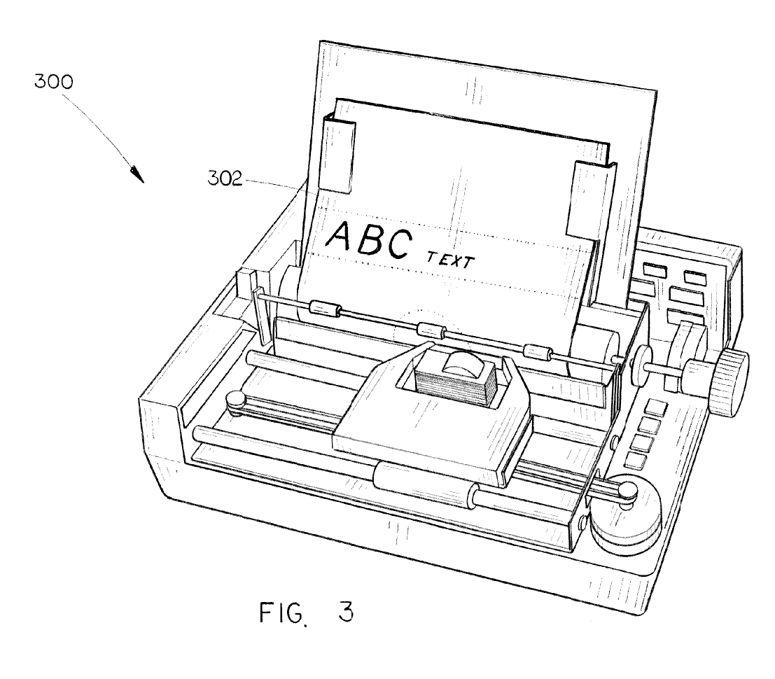

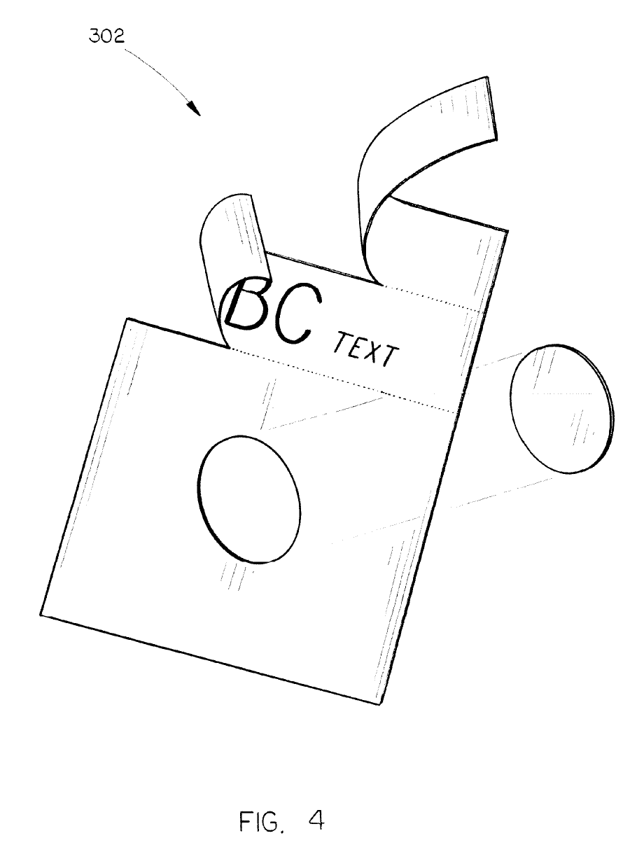

Referring to FIG. 3, an isometric view of a printing device 300 that may provide perforation of a printed surface in accordance with an embodiment of the present invention is shown. A printing device head having elongated impact pins may be implemented with any printing device where a printing device head having impact pins may be installed. Additionally, print head may be retrofit with any existing impact or dot-matrix printing device for enhanced functionality of the printing device. In one embodiment, printing device may be a multiform, serial dot matrix printing device suitable for simultaneously loading multiple forms. Printing device 300 may provide any contemplated printing speed and support various forms of printable media 302, such as cut form paper, continuous form paper, printable transparency film, and the like. Referring to FIG. 4, an illustration of a printing device providing feed-through perforation of a sheet of printable media 302 in accordance with the present invention is shown.

Printing device 300 may be further comprised of a cooling device having a fan or like cooling mechanism for cooling a printing device during the printing operation. For example, cooling device may be comprised of a cooling fan and a motor for driving the cooling fan. In one embodiment of the present invention, a cooling cycle may be included during media perforation operation in order to preserve the life and sharpness of the perforator pins. A cooling cycle may provide additional longevity for a perforating printing device head, reducing the frequency of perforating printing device head replacement installation, and preventing perforating pins from singeing printable media surface.

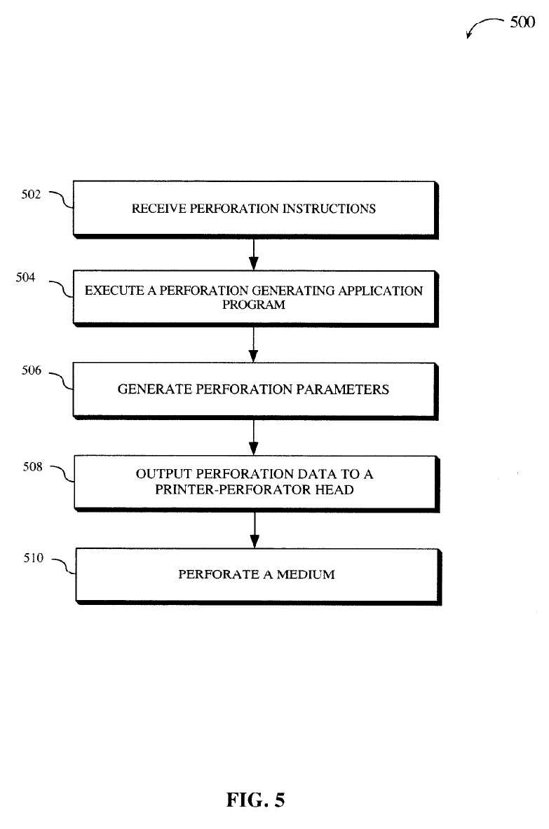

Referring to FIG. 5, a flow diagram representing a process 500 for perforating a printable media surface in accordance with an exemplary embodiment of the present invention is shown. Method may be comprised receiving perforation instructions 502, executing an application program to generate perforation data 504, generating perforation parameters 506, outputting perforation data 408 to a printing device head having a plurality of print impact elements suitable for providing perforation, and perforating a printable media surface 510 according to the columns of perforation data. Generating perforation parameters 506 may be further comprised of defining a total number of columns of perforation data, including a starting block and an ending block. Method 500 may further include determining a number of blocks of perforation data in each column of perforation data based on the starting block of perforation data in each column and the ending block of perforation data in each column of perforation data, allocating an area of memory as a perforation buffer based on the total number of columns of perforation data in each column of perforation data, and reading columns of perforation data.

Method 500 may be suitable for perforating a printable media surface utilizing a compacted perforation code for controlling the operation of the perforating printing device pins of a perforating printing device head to perforate the surface a piece of material. An individual perforating pin may be actuated in sequence to perforate the material along an individual row. Collectively, the perforations of the perforating printing device head print may be in blocks, while the perforating printing device head and material move relative to each other, said perforation blocks being divided into rows and columns of positions in selected ones of which individual positions are perforated by said perforating printing device head to perforate a printable media surface in a desired configuration.

It is further contemplated that the method of coordinate addressing of the perforator print head may be the same as the addressing method of an impact or dot-matrix printing device head printing element known in the art. The level of protrusion of the perforator pins may be determined by the setting of the thickness and paper stock type.

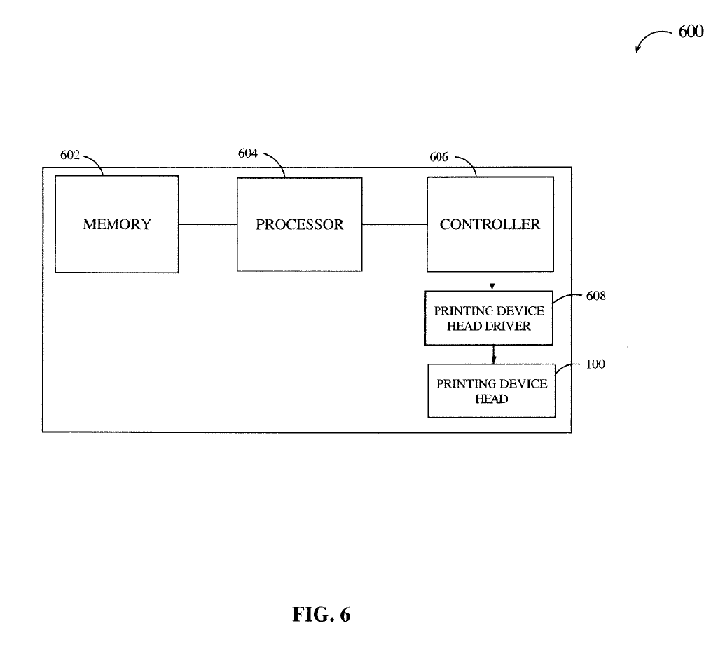

Referring to FIG. 6, a block diagram of a perforating printing system 600 implemented with perforation capabilities in accordance with an exemplary embodiment of the present invention is shown. Perforating printing system 600 may be comprised of a memory 602, an area of which may be designatable as a perforation buffer, a processor 604 suitable for executing an application program to generate medium perforation and determine a configuration for medium perforation, and a controller 606 suitable for receiving the configuration for medium perforation and executing medium perforation. Printing system 600 may receive coded perforation information via an input for a sheet of media to be perforated by the printing device. The coded perforation information for the media to be perforated may be stored in a media memory which may be a separate memory or may be part of a larger memory. As the sheet of media is perforated under control of the system processor 604, which may in turn be controlled by a program in a program memory, the sheet of media may sequentially read out codes from the memory 602 indicating a desired perforation configuration in each row, one row at a time, or for all rows simultaneously, may designate an area of a memory 602 as a perforation buffer for storing perforation data comprised of blocks and columns, and may read out the perforation data from the perforation buffer in order to perforate a sheet of printable media. In one embodiment, the perforating printing system memory 602 may include a random access memory (RAM), an area of which may designatable as a perforation buffer. It is further contemplated, however that any memory, such as a hard drive, read only memory (ROM) or a like memory may be utilized with a perforating printing system 600 of the present invention. The processor 604 may execute an application program to generate perforation data, determine parameters which define a total number of columns of perforation data, a starting block of perforation data in each column of perforation data, and an ending block of perforation data in each column of perforation data, determine a number of blocks of perforation data in each column of perforation data based on the starting block of perforation data in each column of print data and the ending block of perforation data in each column of perforation data, allocate an area of the memory as a perforation buffer based on the total number of columns of perforation data and the number of blocks of perforation data in each column of perforation data, the perforation buffer being defined by a starting address and an ending address, and store the perforation data in the print buffer. A controller 606 may receive from the processor 604 the starting address of the perforation buffer, the ending address of the perforation buffer, the total number of columns of perforation data, and the number of blocks of perforation data in each column of perforation data, read columns of perforation data, one at a time, from the perforation buffer, beginning at the starting address and ending at the ending address, using the total number of columns of perforation data and the number of blocks of perforation data in each column of print data, and output the columns of perforation data, one at a time or simultaneously. System 600 may be further comprised of a perforating printing device head driver 608 suitable for driving a perforating printing head 100. For instance, a perforating printing device head having a plurality of perforating impact elements for perforating a printable media surface, such as the perforating printing device head 100 illustrated in FIG. 1, may receive the columns of perforation data from the controller 606, and perforate an image based on the columns of perforation data output by the controller 606.

A perforating printing device head 100 according to the present invention may be used in multi-color printer plotters, and a color image printing devices, and the like having multi-color ink systems and print impact elements corresponding respectively to multiple ink colors. In one embodiment, a multi-color printer plotter may employ black, red, green, blue and like ink colors, and may move the head or a sheet of print paper or both and project a print impact element corresponding to a desired one of the colors against a printable media surface at a prescribed position thereon to form an ink dot, or perforation. Desired characters, figures and perforation can thus be recorded by repeating the above cycle. In a color image printing device using inks of multiple colors, for instance, black, red, green, blue, or the like, a sheet of printable media may be scanned by a perforating printing device head 100 in a direction perpendicular to the direction of feed of the print paper to form a one-dot line in one scanning stroke, and the printable media may be fed along by line pitches to record images. It is further contemplated that a printing device may utilize ink colors such as black, yellow, magenta, and cyan. In this instance, the colors of red, green, and blue may be formed on a sheet of print paper by superposing inks of at least two colors other than black, thereby recording color images of seven colors.

This invention may be applied to any type of impact dot printer having print wires which are projected from a front end guide. Accordingly, examples of impact dot printers in which this invention may be utilized include clapper-type printing device heads, spring-charged type printing device heads using permanent magnets, piezo-type impact dot printing device heads using piezoelectric elements, and the like.

It is further contemplated that perforating printing head 100 or perforating printing device 300 may perforations may perforate a surface of the medium via electric discharge substantially through the medium. For example, a pointed electrode at the surface of the medium and an electrode or conduction substrate such as a conduction plate may be utilized. In this instance, a several thousand volt pulse may be applied to the pointed electrode or probe. Voltage may be sufficient to substantially break down the dielectric properties of the medium, and an electric arc may transmit substantially through the medium and create one or more perforations. In instances where discoloration due to burning of the medium may occur, discoloration may be minimized by a perforating printing head 100 or perforated printing device 300 emitting a substantially inert gas such as nitrogen, helium, neon, argon and the like about the electrode to reduce the presence of an oxidizer at the time of discharge.

It is even further contemplated that perforating elements comprising a perforating printing head 100 may be sharpened partitioning or cutting devices, such as a series of blades or sharpened edges configured to at multiple angles relative to a medium surface and suitable for impacting the surface of medium. In one embodiment, a blade corresponding most with an angle of the large scale edge to be perforated may be selected. In additional embodiments, any blade or all blades may be utilized to partition the medium surface.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the method and system of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed:

1. A perforating printer head for a printing device comprising:
a frame assembly;
at least one perforating assembly coupled to said frame assembly, said at least one perforating assembly further comprising at least one impact element, said at least one impact element comprising a first end suitable for impacting a medium and a second end suitable for receiving a driving force; and
a drive mechanism suitable for applying said driving force to said second end of said at least one impact element,
wherein said drive mechanism is suitable for applying sufficient driving force to said second end of said impact element to allow said first end of said impact element to perforate said medium.

2. The perforating printer head of claim 1, wherein said drive mechanism further comprises a plurality of permanent magnets and solenoids suitable for actuating said impact element.

3. The perforating printer head of claim 1, wherein said driving force is adjustable according to a type of said medium or a corresponding printer color selection.

4. The perforating printer head of claim 1, wherein said impact element perforates the surface of said medium in a configuration determined from instructions received by a printing device processor configured to execute a perforate action.

5. The perforating printer head of claim 1, wherein said perforating printer head provides at least one level of perforation, wherein said at least one level of perforation comprises a designated driving force to perforate said medium.

6. The perforating printer head of claim 3, wherein said perforating printer head perforates said medium as a mechanism of said printer device receives said medium.

7. The perforating printer head of claim 1, wherein said at least one perforating assembly comprises a perforating-printing element suitable for printing on a surface of said medium and puncturing partially, substantially, or completely through said medium.

8. The perforating printer head of claim 1, wherein said at least one perforating assembly comprises a series of blades or sharpened edge elements configured at multiple angles relative to said medium and suitable for impacting the surface of said medium.

9. A method for partitioning an image on a surface comprising:
receiving perforation instructions;
executing an application program to generate perforation data;
generating parameters defining a total number of columns of said perforation data;
outputting said columns of perforation data to a printing device head having a perforating assembly suitable for perforating and printing a medium; and
perforating said medium according to said columns of perforation data.

10. The method of claim 9, wherein said perforating a medium is adjustable according to a type of said medium or a corresponding printer color selection.

11. The method of claim 9, further comprising allocating an area of memory as a perforation buffer based on the total number of columns of perforation data.

12. The method of claim 9, further comprising reading columns of perforation data.

13. The method of claim 9, further comprising determining a number of blocks of perforation data in each column of perforation data based on the starting block of perforation data in each column and the ending block of perforation data in each column of perforation data.

14. The method of claim 9, further comprising initiating a cooling cycle suitable for cooling said perforating assembly.

15. A printing system comprising:
a perforating printing head having at least one perforating assembly suitable for printing and perforating a medium;
a memory;
a processor suitable for executing an application program to generate perforation data and determine a configuration for perforation from said perforation data; and
a controller suitable for receiving said configuration for said perforation and executing perforation.

16. The printing system of claim 15, wherein said configuration for said perforation is adjustable according to a type of said medium or a corresponding printer color selection.

17. The printing system of claim 15, wherein an area of said memory is designatable as a media perforation buffer.

18. The printing system of claim 15, wherein said perforation data comprises at least one column of perforation data.

19. The printing system of claim 18, wherein said at least one column of perforation data comprises a starting block of perforation data and an ending block of perforation data.

20. The printing system of claim 19, wherein said processor determines said starting block of said perforation data in said at least one column of perforation data, and said ending block of perforation data in said at least one column of perforation data.
